(19) United States
(12) Patent Application Publication
(10) Pub. No.: US 2006/0235819 A1
(43) Pub. Date: Oct. 19, 2006

(54) Apparatus and method for reducing data returned for a database query using select list processing

(75) Inventor: John Matthew Santosuosso, Rochester, MN (US)

Correspondence Address: MARTIN & ASSOCIATES, LLC, P.O. BOX 548, CARTHAGE, MO, 64836-0548, US

(73) Assignee: INTERNATIONAL BUSINESS MACHINES CORPORATION, ARMONK, NY (US)

(21) Appl. No.: 11/106,012

(22) Filed: Apr. 14, 2005

(51) Int. Cl. G06F 17/30

(52) U.S. Cl. 707/1

(57) ABSTRACT

The select statement of a query is processed to determine whether any of the columns in the select statement appear in the predicate of the query. For each column in the select statement that also appears in the predicate of the query, the column may be eliminated from the result set by writing the value for the column in a side data structure. In this manner, the amount of data returned in the result set is reduced, thereby enhancing system performance in running the query.

### BACKGROUND OF THE INVENTION

1. Technical Field

This invention generally relates to computer systems, and more specifically relates to database apparatus and methods.

2. Background Art

Database systems have been developed that allow a computer to store a large amount of information in a way that allows a user to search for and retrieve specific information in the database. For example, an insurance company may have a database that includes all of its policy holders and their current account information, including payment history, premium amount, policy number, policy type, exclusions to coverage, etc. A database system allows the insurance company to retrieve the account information for a single policy holder among the thousands and perhaps millions of policy holders in its database.

Retrieval of information from a database is typically done using queries. A query usually specifies conditions that apply to one or more columns of the database, and may specify relatively complex logical operations on multiple columns. The database is searched for records that satisfy the query, and those records are returned as the query result, which is often referred to as a result set.

One type of query known in the art is a query written in Structured Query Language (SQL). An SQL query typically includes a “select” statement that indicates the data of interest. When a query is processed, a result set is constructed and returned as the query result. In the prior art, the result set includes each and every column in the select statement. However, sometimes the columns in the select statement contain the same data for each row returned due to conditions specified in the query predicate. The amount of data returned affects the performance in processing a query. Without a way to reduce the data returned in the result set for a query, the database industry will continue to suffer from inefficient methods for query processing.

### DISCLOSURE OF INVENTION

According to the preferred embodiments, the select statement of a query is processed to determine whether any of the columns in the select statement appear in the predicate of the query. For each column in the select statement that also appears in the predicate of the query, the column may be eliminated from the result set by writing the value for the column in a side data structure. In this manner, the amount of data returned in the result set is reduced, thereby enhancing system performance in running the query.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a block diagram of an apparatus in accordance with the preferred embodiments;

FIG. 2 is a sample database query;

FIG. 3 is a flow diagram of a prior art method for processing a database query;

FIG. 4 is a sample result set for the query in FIG. 2 in accordance with the prior art;

FIG. 5 is a flow diagram of a method for processing a database query in accordance with the preferred embodiments;

FIG. 6 is sample result set for the query of FIG. 2 in accordance with the preferred embodiments;

FIG. 7 is a sample database query;

FIG. 8 is a sample table for the database query of FIG. 7;

FIG. 9 is a sample result set for the query in FIG. 7 in accordance with the prior art;

FIG. 10 is sample result set for the query of FIG. 7 in accordance with the preferred embodiments;

FIG. 11 is part of a sample database table;

FIG. 12 is a sample database query for the table in FIG. 11;

FIG. 13 is a sample result set for the query in FIG. 12 in accordance with the prior art;

FIG. 14 is a sample result set for the query of FIG. 12 in accordance with the preferred embodiments;

FIG. 15 is a sample database query for the table in FIG. 11;

FIG. 16 is a sample result set for the query in FIG. 15 in accordance with the prior art; and

FIG. 17 is sample result set for the query of FIG. 15 in accordance with the preferred embodiments.

### BEST MODE FOR CARRYING OUT THE INVENTION

1.0 Overview

The present invention relates to the processing of database queries. For those not familiar with databases or queries, this Overview section will provide background information that will help to understand the present invention.

### Known Databases and Database Queries

There are many different types of databases known in the art. The most common is known as a relational database (RDB), which organizes data in tables that have rows that represent individual entries or records in the database, and columns that define what is stored in each entry or record.

To be useful, the data stored in databases must be able to be efficiently retrieved. The most common way to retrieve data from a database is to generate a database query. A database query is an expression that is evaluated by a database manager. The expression may contain one or more select statements and one or more predicate expressions that are used to retrieve data from a database. For example, lets assume there is a database for a company that includes a table of employees, with columns in the table that represent the employee's name, address, phone number, gender, and salary. With data stored in this format, a query could be formulated that would retrieve the records for all female employees that have a salary greater than $40,000. Similarly, a query could be formulated that would retrieve the records for all employees that have a particular area code or telephone prefix.

One popular way to define a query uses Structured Query Language (SQL). SQL defines a syntax for generating and processing queries that is independent of the actual structure and format of the database. Note that an SQL query is expressed in terms of columns defined on one or more database tables. Information about the internal storage of the data is not required as long as the query is written in terms of expressions that relate to values in columns from tables.

2.0 Description of the Preferred Embodiments

The preferred embodiments process a select list in a database query to determine whether any columns in the select list are also in the query predicate. If the query predicate mandates a particular result for a column, the result is indicated in a side data structure, and the column is not included in the result set table. As a result, the amount of data returned in a result set for a query is reduced.

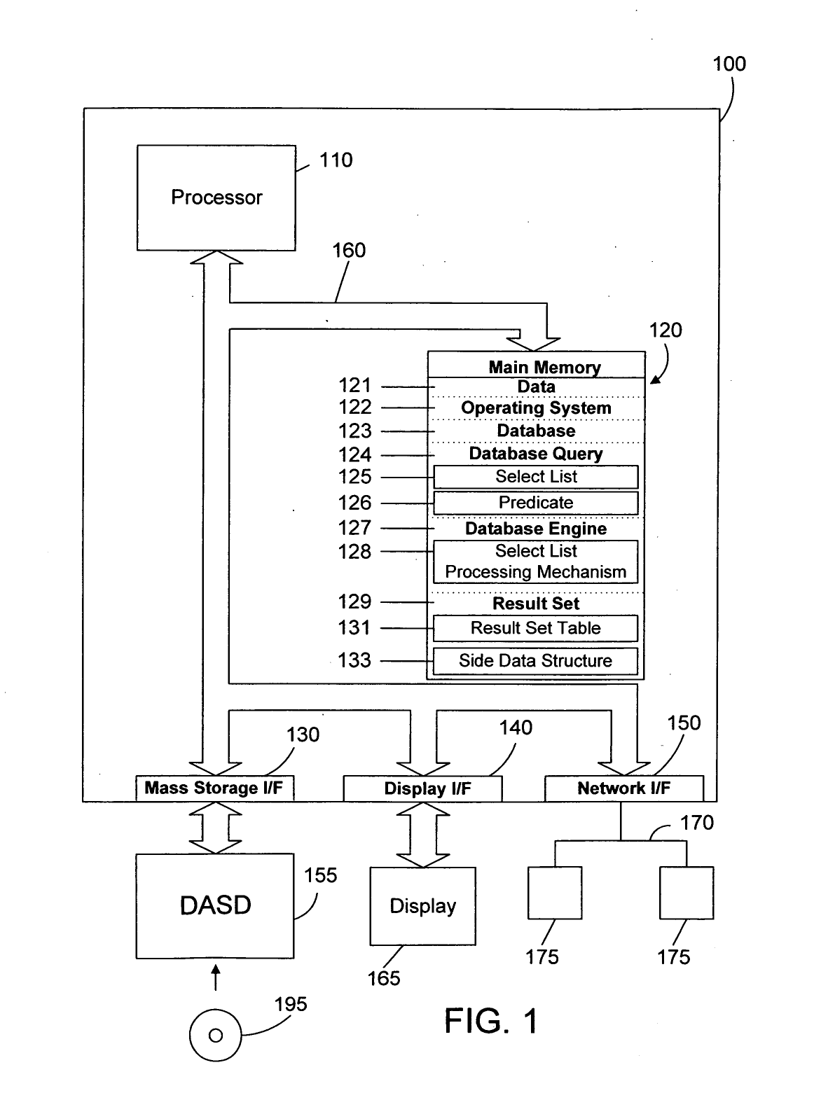

Referring to FIG. 1, a computer system 100 is one suitable implementation of an apparatus in accordance with the preferred embodiments of the invention. Computer system 100 is an IBM eServer iSeries computer system. However, those skilled in the art will appreciate that the mechanisms and apparatus of the present invention apply equally to any computer system, regardless of whether the computer system is a complicated multi-user computing apparatus, a single user workstation, or an embedded control system. As shown in FIG. 1, computer system 100 comprises a processor 110, a main memory 120, a mass storage interface 130, a display interface 140, and a network interface 150. These system components are interconnected through the use of a system bus 160. Mass storage interface 130 is used to connect mass storage devices, such as a direct access storage device 155, to computer system 100. One specific type of direct access storage device 155 is a readable and writable CD RW drive, which may store data to and read data from a CD RW 195.

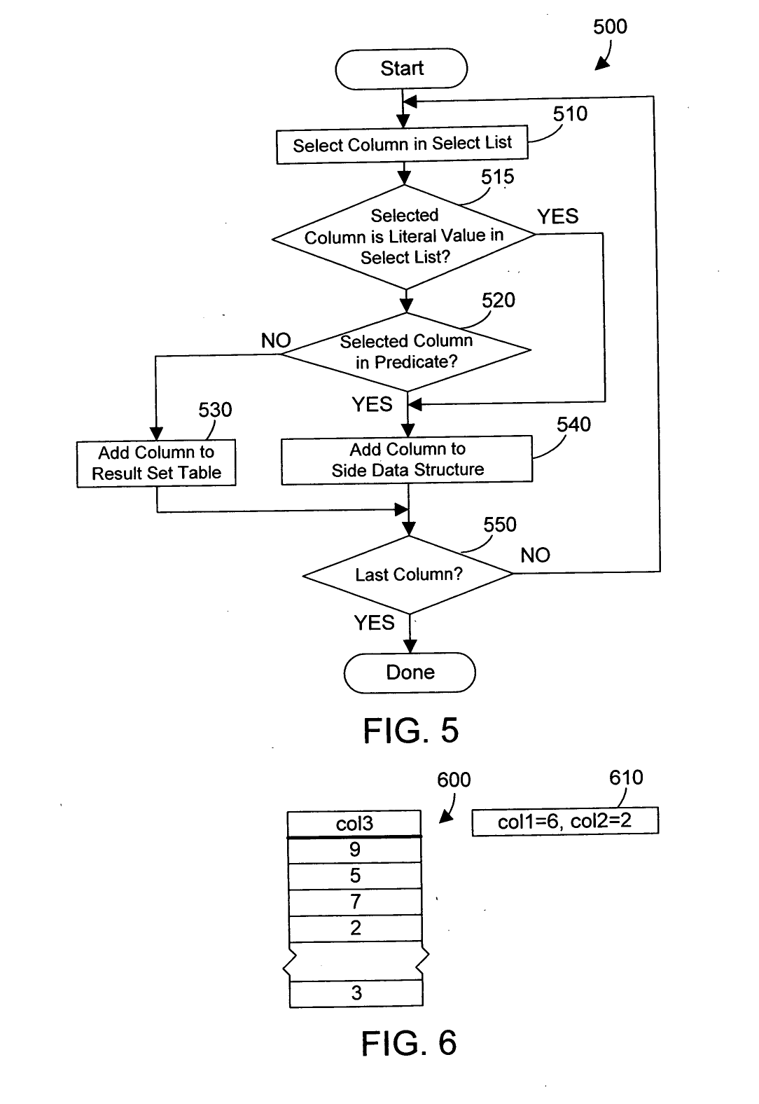

Main memory 120 in accordance with the preferred embodiments contains data 121, an operating system 122, a database 123, one or more database queries 124, a database engine 127, and one or more result sets 129. Data 121 represents any data that serves as input to or output from any program in computer system 100. Operating system 122 is a multitasking operating system known in the industry as OS/400; however, those skilled in the art will appreciate that the spirit and scope of the present invention is not limited to any one operating system. Database 123 is any suitable database, whether currently known or developed in the future. Database 123 preferably includes one or more tables. Database query 124 is a query in a format compatible with the database 123 that allows retrieval of information stored in the database 123 that satisfies the database query 124. Each database query 124 includes a select list 125 that specifies one or more columns to retrieve from the database, and a predicate 126 that specifies one or more conditions that must be met. Predicate 126 may reference one or more columns. Predicate 126 may include a WHERE clause, a HAVING clause, and a GROUPING clause. Of course, other types of clauses that return data could also be used, whether currently known or developed in the future. Database engine 127 processes database queries 124, and in response, returns a result set 129. The database engine 127 includes a select list processing mechanism 128 that determines whether any of the columns in the select list also appear in the query predicate. If so, the query predicate may dictate a particular result for a column (i.e., may return data for the column), which allows the column to be represented in a side data structure 133 instead of as a column in the result set table 131. The result set table 131 includes a column for each column referenced in the select list that is not referenced in the query predicate. The select list processing mechanism 128 effectively reduces the amount of data in the result set 129 by placing one or more columns in the select list into a side data structure 133 that indicates the value(s) for the columns in the select list instead of putting a column into the result set table 131 for each column in the select list. The function of the select list processing mechanism is discussed in more detail below with respect to FIGS. 5-16.

The select list processing mechanism 128 is shown in FIG. 1 to reside in the database engine 127. Note, however, that the select list processing mechanism 128 could reside on either the database server or on the client making the request within the scope of the preferred embodiments.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 121, operating system 122, database 123, database query 124, database engine 127, and result set 129 are shown to reside in main memory 120, those skilled in the art will recognize that these items are not necessarily all completely contained in main memory 120 at the same time. It should also be noted that the term “memory” is used herein to generically refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122. Operating system 122 is a sophisticated program that manages the resources of computer system 100. Some of these resources are processor 110, main memory 120, mass storage interface 130, display interface 140, network interface 150, and system bus 160.

Although computer system 100 is shown to contain only a single processor and a single system bus, those skilled in the art will appreciate that the present invention may be practiced using a computer system that has multiple processors and/or multiple buses. In addition, the interfaces that are used in the preferred embodiment each include separate, fully programmed microprocessors that are used to off-load compute-intensive processing from processor 110. However, those skilled in the art will appreciate that the present invention applies equally to computer systems that simply use I/O adapters to perform similar functions.

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. The present invention applies equally no matter how computer system 100 may be connected to other computer systems and/or workstations, regardless of whether the network connection 170 is made using present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of tangible computer-readable signal bearing media used to actually carry out the distribution. Examples of suitable tangible computer-readable signal bearing media include: recordable type media such as floppy disks and CD RW (e.g., 195 of FIG. 1), and transmission type media such as digital and analog communications links.

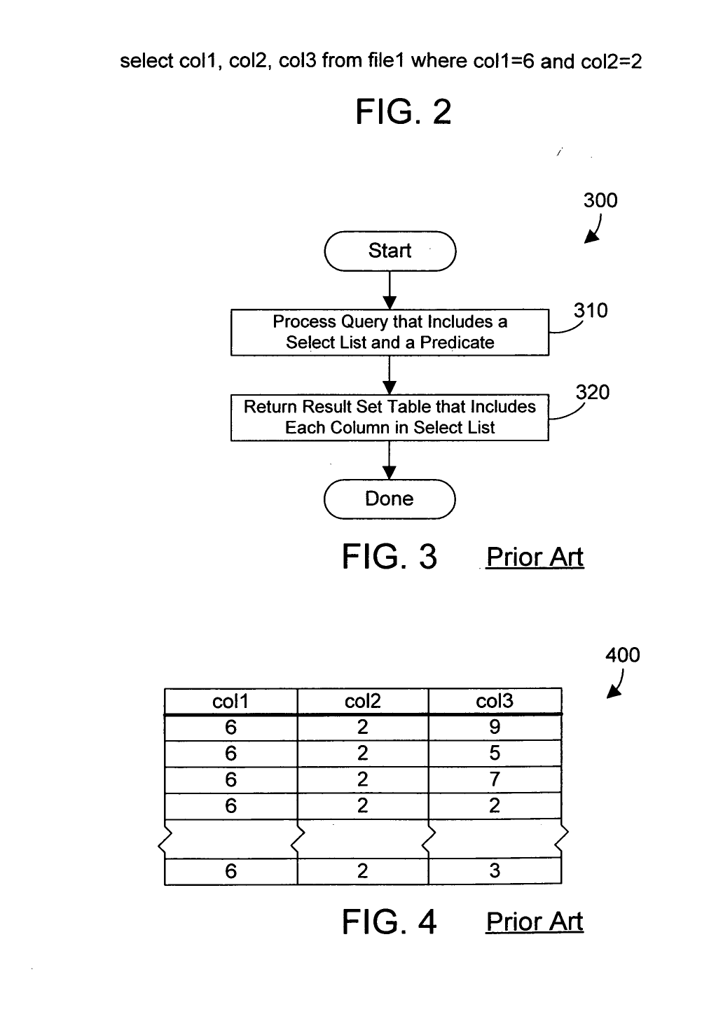

FIG. 2 shows a first sample database query for illustrating the concepts of the preferred embodiments. This query selects three columns col1, col2 and col3 from a table “file1” for all records that have col1=6 and col2=2. Referring to FIG. 3, a prior art method 300 processes the query that includes the select list and the predicate (step 310), and returns a result set table that includes each column in the select list (step 320). One sample result set for the query in FIG. 2 in accordance with the prior art method 300 in FIG. 3 is shown as table 400 in FIG. 4. Table 400 is the prior art result set for the query in FIG. 2 assuming some sample table “file1”. We see from table 400 that the values of column 1 and column 2 are fixed because they are explicitly specified in the predicate in FIG. 2, which is the WHERE clause that specifies that col1=6 and col2=2. Returning separate columns in the result set is wasteful when the values in the columns are fixed, as shown in FIG. 4. The preferred embodiments recognize that the result set need not include full columns in the result set table when the values in the columns are fixed.

Referring to FIG. 5, a method 500 for processing database queries in accordance with the preferred embodiments begins by selecting a column in the select list (step 510). If the selected column is literal value in the select list (step 515=YES), the column is not added to the result set table, but instead is added to a side data structure (step 540). If the selected column is not a literal value in the select list (step 515=NO), we next check to see whether the column is in the query predicate (step 520). If the column is not in the query predicate (step 520=NO), a corresponding column is added to the result set table (step 530). If the selected column is in the predicate (step 520=YES), the column is added to a side data structure (step 540) instead of adding the column to the result set table. If there are more columns in the select list to process (step 550=NO), method 500 loops back to step 510 and continues until all columns in the select list have been processed (step 550=YES). At this point, method 500 is done.

We now apply method 500 in FIG. 5 to the query in FIG. 2. First, col1 is selected in step 510. This column is in the predicate (step 520=YES), as shown by the col1=6 statement in the WHERE clause of the query. As a result, this column is added to a side data structure, along with it's associated value or values (step 540). In this example, col1=6 is specified in the predicate, so step 540 adds col1=6 to the side data structure 610 shown in FIG. 6. There are two more columns in the select list to process (step 550=NO), so we next select col2 from the select list (step 510). Col2 is in the predicate (step 520=YES), so col2=2 is added to the side data structure 610, as shown in FIG. 6 (step 540). There is still another column in the select list to process (step 550=NO), so we now select col3 from the select list (step 510). Col3 is not in the predicate (step 520=NO), so col3 is added as a column of the result set table (step 530). Col3 is the last column in the select list (step 550=YES), so method 500 is done. The result set for the query in FIG. 2 in accordance with the preferred embodiments is shown in FIG. 6. The result set includes a result set table 600 and one or more side data structures 610. Note that the result set table 600 and side data structure 610 are preferably linked together to form a result set. Because the side data structure(s) 610 include columns and their values as specified in the predicate, there is no need to add columns for col1 and col2 to the result set table 600. As a result, the amount of data returned in the result set is greatly reduced, as can be seen visually in the difference between the result set shown in FIG. 6 for the preferred embodiment and the result set shown in FIG. 4 for the prior art.

In the case of JDBC database drivers, we can easily use the metadata that is already being gathered at prepare time to determine if columns are in the select list that are also in the predicate (e.g., in step 520 in FIG. 5). Once this information is known, a new query could be formulated to avoid the unneeded columns in the select list. For example, the query in FIG. 2 could become:

select col3 from file1 where col1=6 and col2=2

This reformulated query removes the unnecessary columns from the select list, thereby reducing the data in the result set.

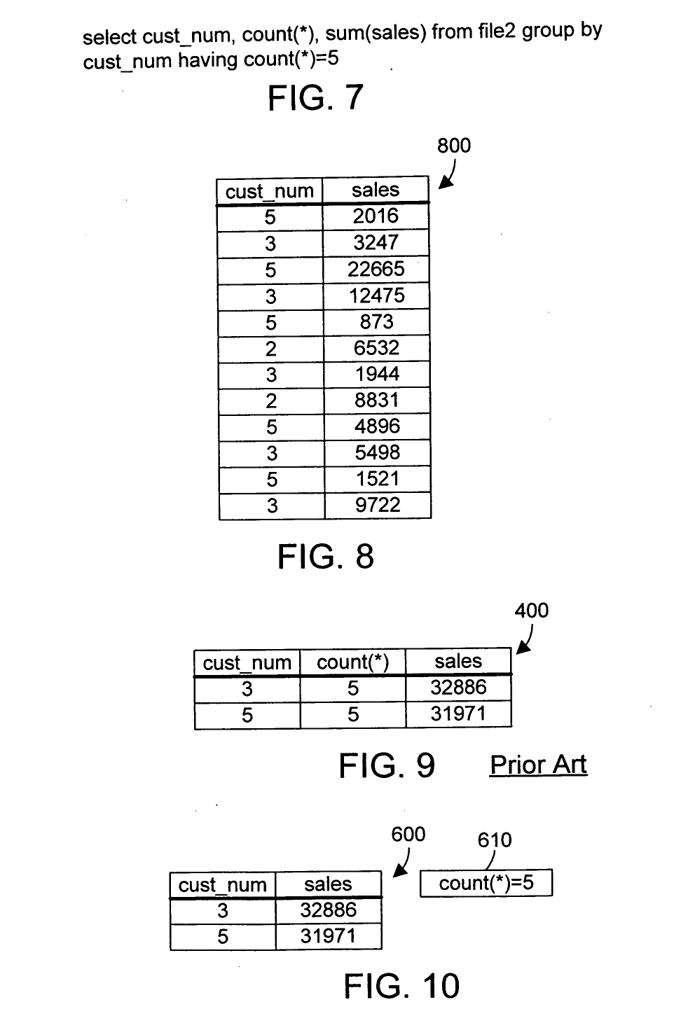

Another sample query is shown in FIG. 7. This query includes a HAVING clause in its predicate that specifies that the count equals five. Note that the count is also referenced in the select list, which includes cust_num, count(*), and sum(sales). A sample database table 800 is shown in FIG. 8 for the query in FIG. 7. The prior art result set table 400 for the query in FIG. 7 is shown in FIG. 9, and includes the cust_num, count and sales columns referenced in the select list. The preferred embodiments, in contrast, recognize that the value for count is the same, and therefore does not create a column in the result set table 600 for count. Instead, count is referenced in a side data structure 610, shown in FIG. 10. One can visually identify from the differences between FIGS. 9 and 10 that the result set of the preferred embodiments returns less data than the prior art result set, thereby enhancing system performance. While the reduction in data between the result sets in FIGS. 9 and 10 may not seem significant for this extremely simplified example, one skilled in the art will realize that many tables includes thousands or millions of rows, and the resulting reduction in data will have a significant impact on system performance.

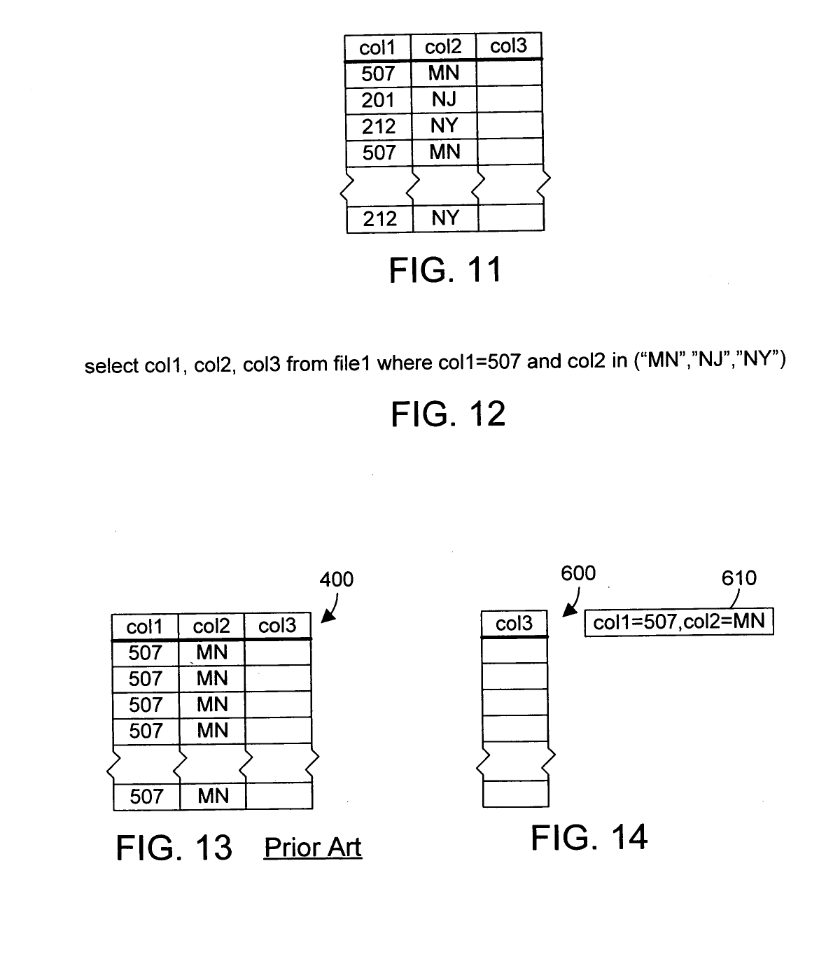

We now present an example to show how select list processing can reduce the data in a result set by analyzing the data itself to see if simplifications may be made. FIG. 11 shows a sample database table that includes three columns, col1, col2 and col3. We assume these columns are part of a larger database table that includes information about people, such as employees of a company. We assume that col1 contains a telephone area code for the employee, that col2 contains the two-letter state code use in the United States Postal System, and that col3 contains some other information for the employee. We now consider the query in FIG. 12. If we assume an index exists over the columns col1 and col2, we may easily find out that for any given value of col1, col2 can only have one value. Therefore, even though the query in FIG. 12 is looking for col2 equaling either MN, NJ or NY, in reality the database already knows that only one value exists. This is the case when an area code is wholly within the boundaries of a state. For the sample query in FIG. 12, the database engine could determine that when col1=507, col2 always equals MN. As a result, col1 and col2 may be removed as columns in from the result set table.

The prior art result set 400 for the query in FIG. 12 and the table in FIG. 11 is shown in FIG. 13. By recognizing that the value for col2 always equals MN when col1=507, both of these conditions may be written to a side data structure 610 shown in FIG. 14. A comparison of the prior art result set in FIG. 13 and the result set of the preferred embodiments in FIG. 14 shows a reduction in the amount of data returned for the query.

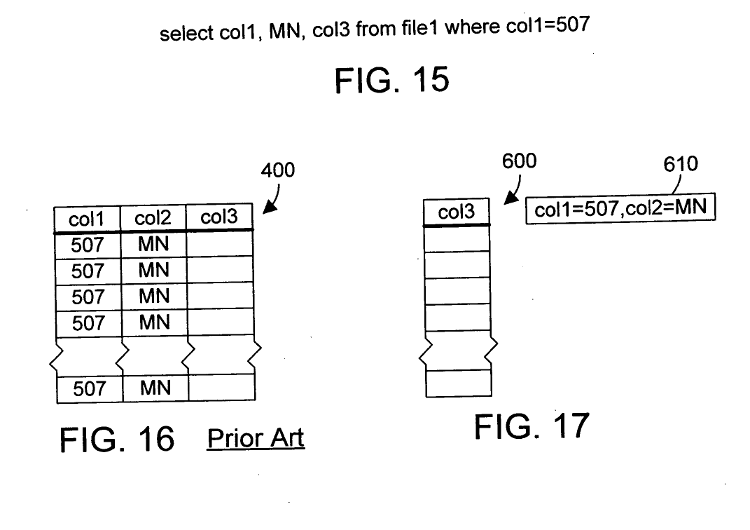

Another method in accordance with the preferred embodiments eliminates literal values in the select list. For this example, we consider the query in FIG. 15, where the literal MN is in the select list. While this may seem like a strange query, application programmers create such queries quite often. One reason the value is hard-coded into SQL is because the SQL layer is abstracted out into extensible Markup Language (XML) documents and the desire to separate the return values from the database to the application logic is a hard requirement. Furthermore, sometimes question marks are used in the select list and then at execution time a literal value is replaced in. Also, certain functions such as CURRENT TIMESTAMP are also literal values such that each row of the result set will contain the same value. The prior art result set 400 for the query in FIG. 15 is shown in FIG. 16. In the preferred embodiments, the database recognizes that the literal MN in the result list need not be a column in the result set, and places both col1=507 and col2=MN in a side data structure 610 shown in FIG. 17. Again, comparing the prior art result set 400 in FIG. 16 with the result set of the preferred embodiments shown in FIG. 17 shows a significant reduction in data returned for the query in FIG. 15. Less data means greater performance for the database system.

Note that result set table 600 and side data structure 610 shown in FIGS. 6, 13 and 16 are specific examples of result set table 131 and side data structure 133 shown in FIG. 1. The result set 129 for each query includes both the result set table 131 and the side data structure 133 shown in FIG. 1. Likewise, the result set shown in FIGS. 6, 13 and 16 includes both the result set table 600 and the side data structure 610. As stated above, the result set table 600 and side data structure 610 are preferably linked together to form the overall result set for the query.

The preferred embodiments reduce the amount of data returned for a database query by processing the select list in the query and determining whether any of the columns in the select list are referenced in the predicate. For any or all columns that are referenced in both the select list and the predicate, the value for the column(s) are written to a side data structure and are not included in the result set table. By eliminating columns in the result set table that contain the same data in each row, the amount of data in the result set is reduced, thereby enhancing system performance.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

What is claimed is:

1. An apparatus comprising:
at least one processor;
a memory coupled to the at least one processor;
a database query residing in the memory and executed by the at least one processor, the database query including a select list and a predicate; and
a select list processing mechanism residing in the memory and executed by the at least one processor, the select list processing mechanism processing the select list in the database query to determine whether the select list references a column referenced in the predicate, and if so, the select list processing mechanism not including the column in a corresponding result set table.

2. The apparatus of claim 1 wherein the select list processing mechanism creates a side data structure that reflects results for the column.

3. The apparatus of claim 1 wherein the predicate comprises a clause that returns data.

4. The apparatus of claim 1 wherein the select list processing mechanism further processes the select list in the database query to determine whether the select list includes a literal value for a corresponding column, and if so, the select list processing mechanism not including the corresponding column in the corresponding result set table.

5. The apparatus of claim 1 wherein the select list processing mechanism rewrites the database query to remove from the select list at least one column that also is referenced in the predicate.

6. The apparatus of claim 1 wherein the select list processing mechanism evaluates metadata for the database and values in the predicate to determine whether a column referenced in the select list may be not included in the corresponding result set table.

7. A computer-implemented method for processing a database query that includes a select list and a predicate, the method comprising the steps of:
(A) processing the select list in the database query to determine whether the select list references a column referenced in the predicate; and
(B) if the select list references a column referenced in the predicate, not including the column in a corresponding result set table.

8. The method of claim 7 further comprising the step of creating a side data structure that reflects results for the column.

9. The method of claim 7 wherein the predicate comprises a clause that returns data.

10. The method of claim 7 further comprising the step of processing the select list in the database query to determine whether the select list includes a literal value for a corresponding column, and if so, not including the corresponding column in the corresponding result set table.

11. The method of claim 7 further comprising the step of rewriting the database query to remove from the select list at least one column that also is referenced in the predicate.

12. The method of claim 7 further comprising the step of evaluating metadata for the database and values in the predicate to determine whether a column referenced in the select list may be not included in the corresponding result set table.

13. A program product comprising:
(A) a select list processing mechanism that processes a select list in a database query to determine whether the select list references a column referenced in the predicate, and if so, the select list processing mechanism not including the column in a corresponding result set table; and
(B) tangible computer-readable signal bearing media bearing the select list processing mechanism.

14. The program product of claim 13 wherein the tangible computer-readable signal bearing media comprises recordable media.

15. The program product of claim 13 wherein the tangible computer-readable signal bearing media comprises transmission media.

16. The program product of claim 13 wherein the select list processing mechanism creates a side data structure that reflects results for the column.

17. The program product of claim 13 wherein the predicate comprises a clause that returns data.

18. The program product of claim 13 wherein the select list processing mechanism further processes the select list in the database query to determine whether the select list includes a literal value for a corresponding column, and if so, the select list processing mechanism not including the corresponding column in the corresponding result set table.

19. The program product of claim 13 wherein the select list processing mechanism rewrites the database query to remove from the select list at least one column that also is referenced in the predicate.

20. The program product of claim 13 wherein the select list processing mechanism evaluates metadata for the database and values in the predicate to determine whether a column referenced in the select list may be not included in the corresponding result set table.
